(19) United States
(12) Patent Application Publication
(10) Pub. No.: US 2020/0059901 A1
(43) Pub. Date: Feb. 20, 2020

(54) ALLOCATING RADIO RESOURCES IN BACKHAUL AND ACCESS LINK

(71) Applicant: Sony Mobile Communications Inc., Tokyo (JP)

(72) Inventors: Bo LARSSON, Malmo (SE); Peter KARLSSON, Lund (SE); Lars NORD, Lund (SE); Daniel LÖNNBLAD, Genarp (SE); Rickard LJUNG, Helsingborg (SE)

(21) Appl. No.: 16/309,597

(22) PCT Filed: Jun. 17, 2016
(86) PCT No.: PCT/EP2016/064059

§ 371 Date: Dec. 13, 2018

(51) Int. Cl. H04W 72/04; H04W 88/04; H04W 72/08

(52) U.S. Cl. CPC H04W 72/042; H04W 72/085; H04W 88/04

(57) ABSTRACT

The present invention relates to a method for allocating radio resources in a wireless communication system (100). According to the method, at a base station (101), a first radio resource for a communication between the base station (101) and a relaying device (104) is determined. The relaying device (104) is configured to relay information between the base station (101) and at least one communication device (301) of the wireless communication system (100) located within a wireless communication range of the relaying device (104). Furthermore, a second radio resource for a communication between the relaying device (104) and the at least one communication device (301) is determined at the base station (101). A message (503) is transmitted from the base station (101) to the relaying device (104). The message (503) comprises information indicating the first radio resource and information indicating the second radio resource.

### FIELD OF THE INVENTION

The present invention relates to a method for allocating radio resources in a wireless communication system, in particular to a method for improving an allocation of radio resources for communication devices attached to the wireless communication system via a direct wireless communication between the communication devices. The present invention relates furthermore to a base station and relaying device implementing the method.

### BACKGROUND OF THE INVENTION

A wireless communication system, for example a cellular-based wireless telecommunication network, which may also be called mobile communication system, may comprise different communications units, so-called network nodes. An exemplary wireless communication system 100 is shown in FIG. 1. The network nodes may comprise for example base stations 101, 201 acting as a wireless interface between an operator core network and the wireless access network. Each base station 101, 201 may provide coverage within a corresponding radio cell 102 and 202. Further network nodes may comprise for example terminal devices 103, 104, 203 and 204 acting as end devices providing radio access communication capabilities. The terminal devices 103, 104, 203 and 204 may comprise machine type communication in wearable and IoT devices, or other consumer oriented devices, such as mobile phones or smart phones.

A typical radio link architecture in wireless communication systems can be described as a direct link topology. As shown in FIG. 1, in such a topology each terminal device is directly connected to one base station via a wireless communication protocol. Typically, a communication from the terminal device to the base station is called uplink, and a communication from the base station to the terminal device is called downlink. For example, terminal device 103 has an uplink connection 105 to the base station 101 and a downlink connection 106 from the base station 101. Likewise, uplink connections 107, 205, 207, and downlink connections 108, 206, 208 are established between the terminal devices 104, 203, 204 and the base stations 101, 201 as shown in FIG. 1. In connection with the present description, uplink and downlink connections between the base station and terminal devices within the coverage of the corresponding base station will be called “direct link”.

For increasing or improving the coverage or capacity of a wireless communication system, further base stations may be installed providing additional radio cells. However, as an alternative, a relaying topology may be utilized in which a mobile terminal device may be connected to a base station either directly or relayed via one or potentially more other mobile terminal devices. Such a relaying topology may enable to dynamically increase the network coverage in poorly covered areas or to support emergency services required for public safety requirements.

FIG. 2 shows the wireless communication system 100 facilitating a relaying topology. Terminal devices 301 to 303, which are located outside the coverage of the cells 102, 202, are coupled to the wireless communication system 100 via relaying the communication via terminal devices which are arranged with in the coverage of the wireless communication system 100. In detail, terminal device 104 may act as a relaying device for relaying information between the terminal device 301 and the base station 101. The communication between the relaying terminal device 104 and the terminal device 301 comprises an uplink connection 304 and a downlink connection 305. The combination of the uplink connection 304 and the downlink connection 305 is also called “sidelink”. The relaying device may relay information of two or more other terminal devices. For example, as shown in FIG. 2, the relaying terminal device 203 may relay information from two terminal devices 302 and 303. A corresponding sidelink comprising an uplink 308 and a downlink 309 may be established between the relaying terminal device 203 and the terminal device 303. A corresponding sidelink comprising an uplink 306 and a downlink 307 may be established between the relaying terminal device 203 and the terminal device 302.

Relaying topologies may be used also for providing connectivity to devices that are within direct link coverage of a base station, so-called in-coverage relaying. FIG. 2 shows a corresponding terminal device 310, which resides in cell 102 of base station 101, but is connected via terminal device 103 acting as a relaying terminal device. A corresponding sidelink comprising an uplink 311 and a downlink 312 may be established between the relaying terminal device 103 and the terminal device 310. The relay functionality may be applied for example to connect a certain type of device that rather should use a sidelink for its communication, or to improve the effective link budget on each link.

In connection with the present description the term “base station” referring for example to items 101, 102, the term “relaying device” referring for example to items 104, 203, and the term “communication device” referring for example to items 301, 302, 303 will be used. The relaying device may comprise a stationary or mobile device capable of relaying information from a communication device. For example, the relaying device may comprise a mobile or stationary terminal device like a mobile telephone or desktop computer with the wireless interface. The communication device may comprise any kind of terminal device, for example a mobile telephone, a notebook computer or a desktop computer. However, these terms shall not be construed for limiting the scope of protection. For example, in view of the terminology used in connection with the standardization in LTE (Long-Term Evolution) of 3GPP (third Generation Partnership Project) a base station may correspond to an eNB (evolved Node B) and the relaying device as well as the communication device may correspond to UE (User Equipment) devices. Furthermore, commonly a communication between the relaying device and the communication device is denoted as device-to-device (D2D) communication.

In many wireless communication systems the base stations are in control of most parts of the communication. The terminal devices connected to the base station are following directives from the base station. These directives may relate to parameter configurations, data traffic scheduling, radio resource control and so on. For the relaying topology there are no direct radio links where the base station is directly involved. Therefore, in particular for parameters that require fast adaption it may be difficult for a base station to control such links. Such fast adapting aspects may comprise in terms of radio resource control for example a selection of radio frequencies and time allocations to be used for the communication between the relaying device and the communication device. For example, a method for LTE D2D communication is specified in Radio Resource Control (RRC) specifications as “sidelink communication configuration” information element (see 3GPP TS 36.331 v 13.1.0 section 6.3.8 “sidelink information elements”). According to the method, the base station provides the relaying device(s) with a general resource allocation block in a static or semi-static manner. This allows the relaying device to determine how to use the allocated resource block. This method may work without significant control signal overhead, but may impact the flexibility of the base station resource control. As an alternative, the base station may provide explicit resource allocation commands for the relayed link(s). However, this may impose a large control signalling overhead on the direct link between the base station and the relaying node.

Therefore, there is a need for a method that allows the base station to have direct control of the relayed links while limiting the amount of control signal overhead.

### SUMMARY OF THE INVENTION

According to the present invention, this objective is achieved by a method for allocating radio resources in a wireless communication system, a base station for a wireless communication system, and a relaying device for a wireless communication system as defined in the independent claims. The dependent claims define preferred and advantageous embodiments of the invention.

According to an aspect of the present invention, a method for allocating radio resources in a wireless communication system is provided. According to the method, a first radio resource for a communication between a base station of the wireless communication system and a relaying device of the wireless communication system is determined at the base station. The relaying device is configured to relay information between the base station and at least one communication device of the wireless communication system located within a wireless communication range of the relaying device. The term “located within a wireless communication range” may relate to a physical arrangement of the relay device and the communication device with respect to each other such that the relay device and the communication device are able to set up a direct radio communication between each other, with no other repeating, amplifying or relaying devices in between. Such a direct radio communication may comprise for example a so-called device-to-device communication. Furthermore, according to the method, a second radio resource for a communication between the relaying device and the at least one communication device is determined at the base station. A message comprising information indicating the first radio resource and information indicating the second radio resource is transmitted from the base station to the relaying device. In other words, a resource allocation for a relayed link between the relaying device and the at least one communication device is attached to a corresponding link control information for a resource allocation between the base station and the relaying device. Therefore, within a single message from the base station to the relaying device, the radio resource control information relating to the link between the base station and the relaying device as well as the radio resource control information relating to the link between the relaying device and the communication device may be transmitted. This may reduce the amount of control signal overhead.

According to an embodiment, the communication between the base station and the relaying device, the so-called direct link communication, may comprise a downlink communication from the base station to the relaying device. The first radio resource comprises a first downlink radio resource for a downlink communication from the base station to the relaying device, and the second radio resource comprises a second downlink radio resource for a downlink communication from the relaying device to the at least one communication device. Additionally or as an alternative, the communication between the base station and the relaying device may comprise an uplink communication from the relaying device to the base station. In this case, the first radio resource comprises a first uplink radio resource for an uplink communication from the relaying device to the base station, and the second radio resource comprises a second uplink radio resource for an uplink communication from the at least one communication device to the relaying device. Therefore, for example depending on required communication capabilities, radio resources for a downlink communication including the direct link and the sidelink from the base station via the relaying device to the communication device as well as radio resources for an uplink communication including the direct link and the sidelink from the communication device via the relaying device to the base station may be transmitted within a single message thus reducing communication overhead amount.

According to another embodiment, a radio resource request is transmitted from the relaying device to the base station. The radio resource request comprises a request for a radio resource for a communication between the base station and the relaying device, and additionally a request for a communication between the relaying device and the at least one communication device. By combining the radio resource request for the sidelink and the direct link into a single request message, a communication overhead may be reduced already during requesting radio resources from the base station.

Furthermore, the relaying device may be configured to relay information between the base station and a plurality of communication devices located within a wireless communication range of the relaying device. For example, the relaying device may be configured to relay information of two or more communication devices, for example 5 to 10 communication devices. However, for each of the communication devices whose information is to be relayed, corresponding radio resources are required. Therefore, a radio resource request is transmitted from the relaying device to the base station which comprises a request for a radio resource for the communication between the base station and the relaying device and additionally the corresponding requests for each communication between the relaying device and the corresponding communication devices. I.e., a single radio resource request message comprises a radio resource request for the direct link between the base station and the relaying device as well as radio resource requests for all sidelinks between the relaying device and the communication devices. This may reduce communication overhead and additionally an assignment of the radio resources by the base station may be optimized and/or simplified.

For setting up the radio resource request for requesting the radio resources for the direct link and the sidelinks, from each of the plurality of communication devices a corresponding radio resource request may be transmitted to the relaying device.

Furthermore, the relaying device may modify the radio resource requests from the plurality of communication devices before transmitting the collective radio resource requests to the base station. The radio resource requests are modified for coordinating the plurality of radio resource requests before transmitting the radio resource requests to the base station. For example, the radio resource requests may be modified based on a prioritization by the relaying device among the different sidelinks. For example, if the total amount of resources requested by the communication devices exceeds the amount of available resources to the relaying device, one communication device may be granted 70% of its request, another communication device may be granted 50% of its request, and yet another communication device may be granted 30% of its request. These prioritization levels could, for example, be based on how critical their communication needs are (respirator vs. game console) or based on a radio signal strength indication (RSSI) at the sidelink from the communication device to the relaying device, for example to conserve power. Additionally or as an alternative, resource requests may also be modified without prioritization, for example all resource requests may be modified in the same way. The modification may consider further constraints, for example the total amount of resource allocations, or power restrictions at the relaying device. For example, if the relaying device is low on battery, it may limit (or even block) the resource requests to save power, even if the requested resources are available.

According to an embodiment, the at least one communication device is detected by the relaying device, and the radio resource request is transmitted from the relaying device to the base station upon detecting the at least one communication device. Thus, a quick and immediate integration of the communication device into the wireless communication system may be utilized.

According to another embodiment, the relaying device is configured to relay information or data between the base station and a plurality of communication devices located within a wireless communication range of the relaying device. When determining the second radio resource at the base station, the base station determines for each communication device of the plurality of communication devices a corresponding second radio resource for the communication between the relaying device and the corresponding communication device. In other words, the second radio resource comprises corresponding radio resource information for each of the communication devices communicating with the relaying device. Thus, radio resource information for each of the plurality of communication devices may be transmitted from the base station to the relaying device within one message in combination with the first radio resource. This may contribute to reduce the amount of communication overhead for distributing radio resource information.

According to another embodiment, the information indicating the second radio resource comprises a relative information indicating the second radio resource relatively with respect to the first radio resource. For example, the relative information may comprise a frequency offset between a centre frequency of the second radio resource and a center frequency of the first radio resource. Additionally or as an alternative, the relative information may comprise a ratio of a transmission bandwidth of the second radio resource with respect to a transmission bandwidth of the first radio resource. Furthermore, additionally or as an alternative, the relative information may comprise a timing offset between a transmission time interval or time slot of the second radio resource and a transmission time interval or time slot of the first radio resource. By specifying the radio resources for the sidelinks as relative information, the amount of information to be transmitted may be reduced. Furthermore, in case at a later point in time the base station decides to change the radio resources for the direct link and the sidelinks, wherein the relative relation remains unchanged, the base station may only transmit an update for the direct link connection.

Finally, according to an embodiment, after the first radio resource information and the second radio resource information has been distributed, data may be transmitted from the at least one communication device to the relaying device using the second radio resource, and data from the relaying device may be transmitted to the base station using the first radio resource.

According to another embodiment of the method, the method comprises furthermore to determine, at the relaying device, a first channel quality information relating to the communication between the base station and the relaying device. Furthermore, at the relaying device, a second quality information relating to the communication between the relaying device and the at least one communication device may be determined. The first and second channel quality information may be transmitted from the relaying device to the base station. In the base station, the first radio resource may be determined depending on the first channel quality information, and the second radio resource maybe determined depending on the second channel quality information.

For example, the relaying device may transmit a channel quality information message in the uplink, wherein the channel quality information may indicate the channel quality estimated for the downlink channel. In such a channel quality information message the relaying device may also include additional sidelink channel quality information. The base station may potentially use this information for its future resource allocation decisions, for example to avoid resource allocation that results in a low channel quality for the sidelink. The sidelink channel quality information may include information for both sidelink directions, uplink and downlink related channel quality information.

When transmitting the channel quality information message from the relaying device to the base station, the channel quality information message may comprise the first and second quality information. Thus, the communication amount for transmitting the channel quality information may be reduced.

According to another aspect of the present invention, a base station for a wireless communication system is provided. The base station comprises a transceiver and a processing unit. The processing unit is configured to determine a first radio resource for a communication via the transceiver between the base station and the relaying device of the wireless communication system. The relaying device is configured to relay information between the base station and at least one communication device of the wireless communication system, wherein the at least one communication device is located within a wireless communication range of the relaying device. The processing unit is furthermore configured to determine a second radio resource for a communication between the relaying device and the at least one communication device. Finally, the processing unit is configured to transmit a message to the relaying device which comprises information indicating the first radio resource and information indicating the second radio resource. Therefore, the base station may be configured to perform the above-described methods and embodiments and comprises therefore the above-described advantages.

According to another aspect of the present invention, a relaying device for a wireless communication system is provided. The relaying device comprises a transceiver and a processing unit. The processing unit is configured to relay, via the transceiver, information between a base station of the wireless communication system and at least one communication device of the wireless communication system, wherein the at least one communication device is located within a wireless communication range of the relaying device. In other words, the relaying device is configured to act as a relay in a device-to-device communication. The processing unit is furthermore configured to receive a message from the base station. The message comprises information indicating a first radio resource and information indicating a second radio resource. The first radio resource is determined by the base station for the communication between the base station and the relaying device. The second radio resource is determined by the base station for the communication between the relaying device and the at least one communication device. Based on the message received from the base station, the relaying device may establish a communication to the base station using the first radio resource and may establish a communication to the at least one communication device using the second radio resource. Furthermore, the relaying device may be configured to perform the above-described methods and embodiments and comprises therefore the above-described advantages.

According to an embodiment, the relaying device may comprise a mobile telephone, a smart phone, a personal digital assistant, a wearable electronic equipment, a mobile music player, a mobile computer, or a mobile navigation system. A wearable electronic equipment, also called wearable device or smart mobile accessory, may comprise a wearable computer, also known as body born computer or simply wearable, which is the miniature electronic device that may be worn by a user under, with or on top of clothing. Thus, in principle, each terminal device used in the wireless communication system may act as the relaying device for relaying information of another terminal device to the base station.

Although specific features described in the above summary and the following detailed description are described in connection with specific embodiments and aspects of the present invention, it should be noticed that the features of the exemplary embodiments and aspects described herein may be combined with each other unless specifically noted otherwise.

### BRIEF DESCRIPTION OF THE DRAWINGS

The present invention will be described in more detail with reference to the accompanying drawings.

FIG. 1 shows schematically a wireless communication system according to an embodiment of the present invention.

FIG. 2 shows schematically a wireless communication system including a device-to-device communication according to an embodiment of the present invention.

FIG. 3 shows schematically details of a base station and a relaying device according to embodiments of the present invention.

FIG. 4 shows schematically a message flow between a base station, a relaying device, and a communication device according to an embodiment of the present invention.

FIG. 5 shows a relative allocation of radio resources according to an embodiment of the present invention.

### DETAILED DESCRIPTION OF PREFERRED EMBODIMENTS

In the following, exemplary embodiments of the present invention will be described in more detail. It is to be understood that the features of the various exemplary embodiments described herein may be combined with each other unless specifically noted otherwise. Any coupling between components or devices shown in the Figures may be a direct or indirect coupling unless specifically noted otherwise. Same reference signs in the various drawings refer to similar or identical components.

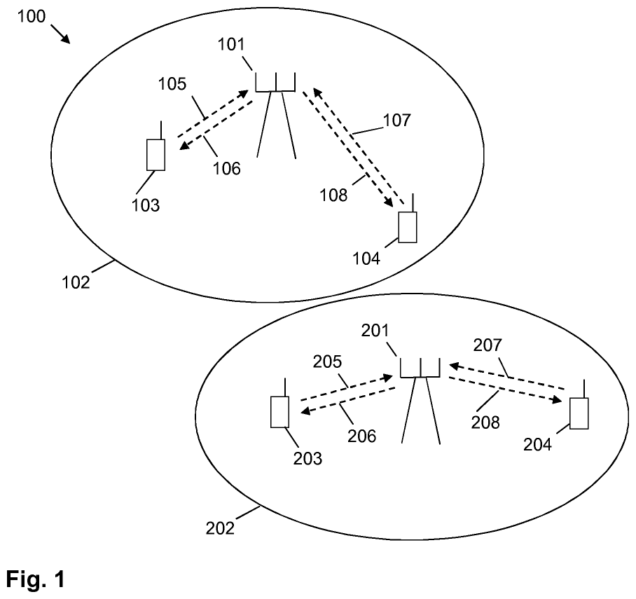

FIG. 1 shows schematically a wireless communication system 100, for example a cellular-based wireless telecommunication network. The wireless communication system 100 may comprise a plurality of base stations 101, 201. The base stations may communicate with each other via wireless radio communications or via an operator core network. The base station 101 serves a radio cell 102 in which terminal devices 103, 104 may communicate directly with the base station 101 via a radio frequency communication indicated by the dashed arrows 105 to 108. In detail, a direct uplink 105 may be provided for communicating data from the terminal device 103 to the base station 101, and a direct downlink 106 may be provided for communicating data from the base station 101 to the terminal device 103. Likewise, a direct uplink 107 may be provided for communicating data from the terminal device 104 to the base station 101, and a direct downlink 108 may be provided for communicating data from the base station 101 to the terminal device 104. The base station 201 serves a radio cell 202 in which terminal devices 203, 204 may communicate directly with the base station 201. A direct uplink 205 and a direct downlink 206 may be provided between the base station 201 and the terminal device 203, and a direct uplink 207 and a direct downlink 208 may be provided between the base station 201 and the terminal device 204. A terminal device outside the radio cells 102, 202 cannot communicate directly with the base stations 101, 201 due to insufficient radio frequency range.

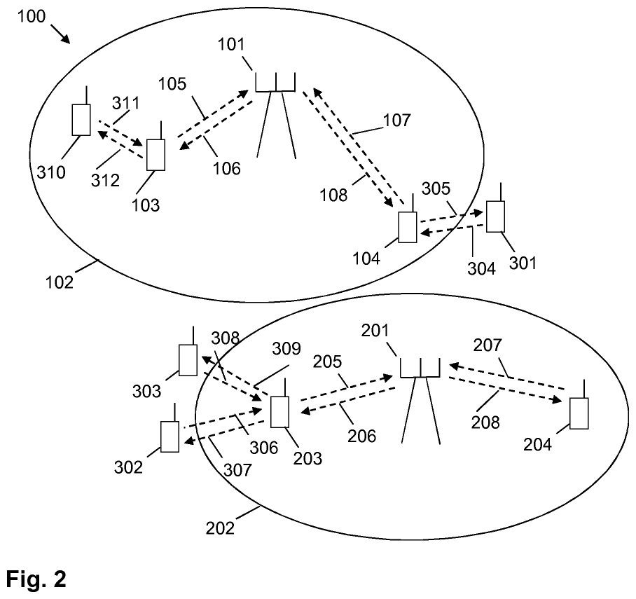

FIG. 2 shows schematically how to extend the coverage provided by the base stations 101 and 201. For example, terminal devices 104 and 301 may use a so-called device-to-device (D2D) communication to discover that they are within a radio frequency range of each other. Likewise the terminal devices 302 and 303 may discover via a device-to-device communication that they are within a radio frequency range of the terminal device 203. Communication links may be established between the terminal devices 104, 203 within the cells and the terminal devices 301-303 located outside the cells 102, 202. For example, a so-called sidelink comprising a down-sidelink 305 and an up-sidelink 304 may be established between the terminal device 104 and the terminal device 301. The terminal device 104 may then act as a relaying device for relaying information from the terminal device 301 to the base station 101 and vice versa. In the same way, an up-sidelink 306 and a down-sidelink 307 may be established between the terminal device 203 and the terminal device 302, and an up-sidelink 308 and a down-sidelink 309 may be established between the terminal device 303 and the terminal device 203. The terminal device 203 is therefore acting as a relaying device for the terminal devices 302 and 303. In the following, terminal devices which perform a relaying function like terminal devices 104 and 203 will be called relaying device, and terminal devices located outside the cells 102, 202 and connected via a device-to-device communication will be called communication device.

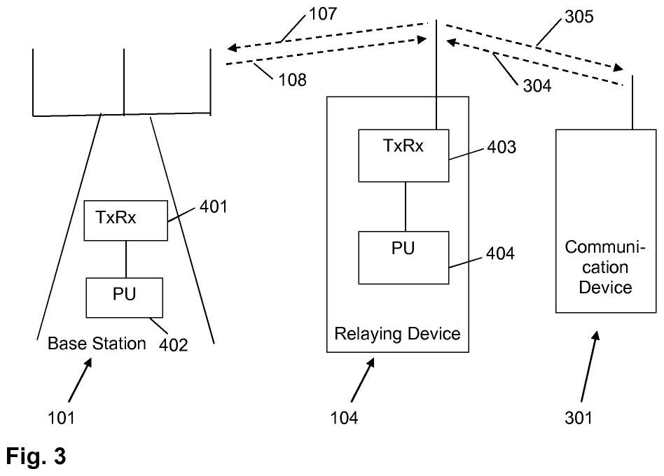

FIG. 3 shows the base station 101, the relaying device 104 and the communication device 301 in more detail. The base station 101 comprises a transceiver (TxRx) 401 and a processing unit (PU) 402. The relaying device 104 comprises a transceiver (TxRx) 403 and a processing unit (PU) 404. The communication device 301 may comprise also a transceiver and a processing unit, but these details are not shown in FIG. 3 for clarity reasons. The direct uplink 107 and the direct downlink 108 as well as the up-sidelink 304 and the down-sidelink 305 are also shown in FIG. 3.

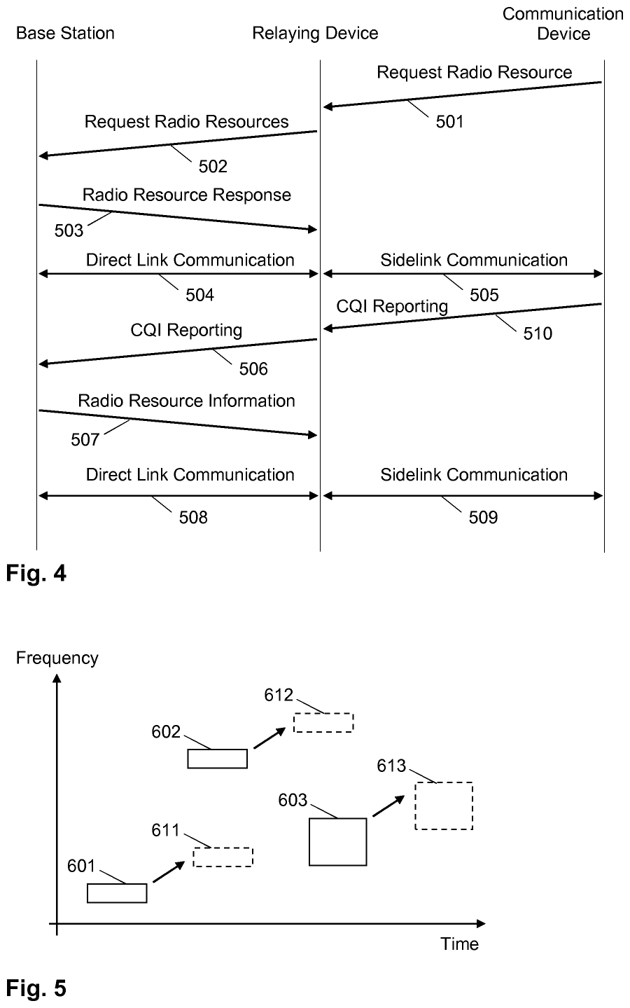

Typically, in wireless communication systems like the wireless communication system 100, the base stations 101, 201 are in control of most parts of the communication. In particular the base stations 101, 201 may control the use of radio resources used for wireless communication. For establishing sidelinks 304-309 and 311, 312, pre-allocated resource blocks may be provided. However, this may reduce capacity. Therefore, radio resources may be allocated as will be described in more detail in the following in connection with FIGS. 4 and 5.

In the following, reference will be made mainly to the communication between the base station 101, the relaying device 104 and the communication device 301. However, although not explicitly noted, the same mechanisms and techniques may be used for the communication between the base station 201, the relaying device 203 and the communication devices 302 and 303.

As shown in FIG. 4, communication device 301 may send a radio resource request 501 to the relaying device 104 after having detected that the communication device 301 and the relaying device 104 are with in a radio frequency range for a device-to-device communication. The relaying device 104 receives the radio resource request 501 from the communication device 301. In case a plurality of communication devices are with in a radio frequency range for a device-to-device communication, the relaying device 104 may receive a plurality of corresponding radio resource requests from each of the communication devices. For example the relaying device 203 of FIG. 2 may receive a radio resource request from the communication device 302 and a further radio resource request from the communication device 303.

In case of multiple radio resource requests 501 from a plurality of communication devices, the relaying device 104 may coordinate the multiple resource needs into a combined resource need for the multiple sidelinks. Additionally, the relaying device 104 may modify the radio resource requests from the communication devices connected via the sidelinks. The modification may be based for example on a prioritization by the relaying device among the different sidelinks, taking into account the total amount of resources to be allocated. For its own communication with the base station 101, the relaying device 104 may also want to request radio resources from the base station 101. Therefore, the relaying device 104 may transmit a message 502 to the base station including a request for radio resources for the communication devices coupled via a device-to-device communication as well as a request for radio resources for the communication between the relaying device 104 and the base station 101.

Note that the scheduling request in the uplink direction may be triggered based on a relay request from the communication device 301 requesting a specific relaying device 104 to start relaying uplink data. The relay request may use discovery resources that are autonomously allocated. The relay request or a following packet from the communication device may include an uplink buffer size used later in the scheduling request generated by the relaying device 104.

In response to the message 502 the base station 101 may transmit a radio resource response 503 to the relaying device 104. The radio resource response 503 includes radio resources for the direct link communication between the base station 101 and the relaying device 104 as well as radio resources for the sidelink communication between the relaying device 104 and the communication device 301. The radio resource response 503 may include the radio resources for the direct link and the sidelink in uplink direction. The relaying device 104 may extract from the message 503 the allocated radio resources for the sidelink in uplink direction and communicate this to the communication device 301. Additionally or as an alternative, the radio resource response 503 may include the radio resources for the direct link and the sidelink in the downlink direction. The radio resource requests and the responded resource allocation for the relayed sidelinks may be indicated relatively to the radio resource request and the responded resource allocation of the direct link. The relation may be in terms of needed resources for the request, for example asking for the same amount or twice the amount or other levels of transmission capacity as in the direct link request. In this manner, the resource allocation for the sidelink will be communicated with very little additional control signalling overhead. Furthermore, this relation between direct link and sidelink allocation could be in terms of time and/or frequency on schedule grants, for example specifying that the sidelink resources are allocated later in time, and/or higher or lower in frequency. This relative indication can be sent per request and/or response, or may be static or semi-static. A semi-static indication allows that the parameters for the sidelink may be optional and are considered to be the same values as long as no new indication is signalled. FIG. 5 shows schematically resources 601 to 603 allocated for the direct link and relatively allocated resources 611 to 613 for a sidelink. In the example shown in FIG. 5 it is assumed that the sidelink allocation is scheduled in relation to a direct link allocation with a relative indication “same amount of resources, one frequency step higher and two time slots later”. Note that this example is only illustrative and in a real implementation the frequency steps and timeslots may be clearly defined, for example using a frequency in megahertz, a number of sub carriers, defined frequency bands and so on for frequency steps, and a value of milliseconds or a transmission time interval, frames and so on for the time granularity.

If the relaying device 104 has combined several sidelink resource needs into one resource request 502, the relaying device 104 may distribute the allocated combined sidelink resources received via the radio resource response 503 into different sidelink transmissions according to individual sidelink resource needs (not shown in FIG. 4).

Using the allocated radio resources of the response 503, a direct link communication 504 may be established between the base station 101 and the relaying device 104 as well as a sidelink communication 505 may be established between the relaying device 104 and the communication device 301.

Optionally, the relaying device 104 may transmit a channel quality indication (CQI) reporting 506 in the uplink to the base station 101. The CQI may indicate the channel quality as estimated for the downlink channel of the direct link between the base station 101 and the relaying device 104. Additionally, the CQI reporting 506 may also include additional sidelink CQI information determined based on a communication over the sidelink between the relaying device 104 and the communication device 301. The base station 101 may use this information in its future resource allocation decisions, for example to avoid channel allocation that results in low CQI reports for the sidelink. The sidelink information may include up-sidelink and/or down-sidelink related information. The down-sidelink related quality information may be reported from the communication device 301 to the relaying device 104 via a corresponding CQI reporting 510. Future resource allocation decisions from the base station 101 may be transmitted via a radio resource information message 507 which may contain essentially the same information as the radio resource response 503.

Based on the allocated radio resources of the radio resource information 507, a direct link communication 508 may be established between the base station 101 and the relaying device 104, and a sidelink communication 509 may be established between the relaying device 104 and the communication device 301.

The above-described method allows the base station 101 to allocate sidelink transmission resources for both, when scheduling uplink grants and when scheduling downlink transmissions. Note that the base station 101 may utilize only one of these opportunities.

1. A method for allocating radio resources in a wireless communication system, the method comprising:
determining, at a base station of the wireless communication system, a first radio resource for a communication between the base station and a relaying device of the wireless communication system, the relaying device being configured to relay information between the base station and at least one communication device of the wireless communication system located within a wireless communication range of the relaying device,
determining, at the base station, a second radio resource for a communication between the relaying device and the at least one communication device, and
transmitting a message from the base station to the relaying device, the message comprising information indicating the first radio resource and information indicating the second radio resource.

2. The method according to claim 1, wherein the communication between the base station and the relaying device comprises at least one of:
a downlink communication from the base station to the relaying device, wherein the first radio resource comprises a first downlink radio resource for the downlink communication from the base station to the relaying device, and the second radio resource comprises a second downlink radio resource for a downlink communication from the relaying device to the at least one communication device, and
an uplink communication from the relaying device to the base station, wherein the first radio resource comprises a first uplink radio resource for the uplink communication from the relaying device to the base station, and the second radio resource comprises a second uplink radio resource for an uplink communication from the at least one communication device to the relaying device.

3. The method according to claim 1, wherein the method further comprises:
transmitting a radio resource request from the relaying device to the base station, the radio resource request comprising a request for a radio resource for a communication between the base station and the relaying device and a request for a radio resource for a communication between the relaying device and the at least one communication device.

4. The method according to claim 3, wherein the relaying device is configured to relay information between the base station and a plurality of communication devices located within a wireless communication range of the relaying device,
wherein transmitting the radio resource request comprises:
transmitting a radio resource request from the relaying device to the base station, the radio resource request comprising a request for a radio resource for the communication between the base station and the relaying device, and corresponding requests for each communication between the relaying device and a corresponding communication device of the plurality of communication devices.

5. The method according to claim 4, further comprising:
transmitting from each of the plurality of communication devices a corresponding radio resource request to the relaying device.

6. The method according to claim 5, further comprising:
modifying the radio resource requests from the communication devices at the relaying device for coordinating the radio resource requests before transmitting the radio resource requests to the base station.

7. The method according to claim 3, wherein transmitting the radio resource request comprises:
detecting, by the relaying device, the at least one communication device, and
transmitting the radio resource request upon detecting the at least one communication device.

8. The method according to claim 1, wherein the relaying device is configured to relay information between the base station and a plurality of communication devices located within a wireless communication range of the relaying device,
wherein determining the second radio resource comprises:
determining, at the base station, for each communication device of the plurality of communication devices a corresponding second radio resource for a communication between the relaying device and the corresponding communication device.

9. The method according to claim 1, wherein the information indicating the second radio resource comprises a relative information indicating the second radio resource relatively with respect to the first radio resource.

10. The method according to claim 9, wherein the relative information comprises at least one of:
a frequency offset between a center frequency of the second radio resource and a center frequency of the first radio resource,
a ratio of a transmission bandwidth of the second radio resource with respect to a transmission bandwidth of the first radio resource, and
a timing offset between a transmission time interval of the second radio resource and a transmission time interval of the first radio resource.

11. The method according to claim 1, the method further comprising:
transmitting data from the at least one communication device to the relaying device using the second radio resource, and
transmitting the data from the relaying device to the base station using the first radio resource.

12. The method according to claim 11, further comprising:
determining, at the relaying device, a first channel quality information relating to the communication between the base station and the relaying device,
determining, at the relaying device, a second channel quality information relating to the communication between the relaying device and the at least one communication device, and
transmitting the first and second channel quality information from the relaying device to the base station.

13. The method according to claim 12, wherein determining the first radio resource comprises:
determining the first radio resource depending on the first channel quality information.

14. The method according to claim 12, wherein determining the second radio resource comprises:
determining the second radio resource depending on the second channel quality information.

15. The method according to claim 12, wherein transmitting the first and second channel quality information from the relaying device to the base station comprises:
transmitting a quality message from the relaying device to the base station, the quality message comprising the first and second quality information.

16. A base station for a wireless communication system, the base station comprising:
a transceiver, and
a processing unit configured to
determine a first radio resource for a communication between the base station and a relaying device of the wireless communication system, the relaying device being configured to relay information between the base station and at least one communication device of the wireless communication system located within a wireless communication range of the relaying device,
determine a second radio resource for a communication between the relaying device and the at least one communication device, and transmit a message to the relaying device, the message comprising information indicating the first radio resource and information indicating the second radio resource.

17. (canceled)

18. A relaying device for a wireless communication system, the relaying device comprising:
a transceiver, and
a processing unit configured to
relay information between a base station of the wireless communication system and at least one communication device of the wireless communication system located within a wireless communication range of the relaying device, and
receive a message from the base station, the message comprising information indicating a first radio resource and information indicating a second radio resource, the first radio resource being determined by the base station for a communication between the base station and the relaying device, and the second radio resource being determined by the base station for a communication between the relaying device and the at least one communication device.

19. (canceled)
